(19) United States
(12) Patent Application Publication
(10) Pub. No.: US 2021/0395102 A1
(43) Pub. Date: Dec. 23, 2021

(54) METHOD FOR MANUFACTURING COMPOSITE CARBONATE BY USING COMBUSTION ASH

(71) Applicant: KOREA INSTITUTE OF CERAMIC ENGINEERING AND TECHNOLOGY, Jinju-si, Gyeongsangnam-do (KR)

(72) Inventors: Woo Teck KWON, Jinju-si, Gyeongsangnam-do (KR); Jung Hyun KIM, Jinju-si, Gyeongsangnam-do (KR); Yoon Joo LEE, Jinju-si, Gyeongsangnam-do (KR); Dong Geun SHIN, Jinju-si, Gyeongsangnam-do (KR); Jung Won BANG, Hanam-si, Gyeonggi-do (KR)

(21) Appl. No.: 17/294,818

(22) PCT Filed: Mar. 12, 2019
(86) PCT No.: PCT/KR2019/002840

§ 371 Date: May 18, 2021

(30) Foreign Application Priority Data
Dec. 13, 2018 (KR) 10-2018-0161364

(51) Int. Cl. C01F 11/18; C04B 14/28

(52) U.S. Cl. CPC C01F 11/18; C04B 2111/00663; C04B 14/28

(57) ABSTRACT

The present invention provides a method for manufacturing a composite carbonate in a semi-dry manner by using combustion ash and, more specifically, provides a method for manufacturing a composite carbonate in a semi-dry manner by using combustion ash, the method comprising a step of adding a small amount of water to combustion ash containing calcium ions in an atmosphere of carbon dioxide. According to the present invention, carbon mineralization is carried out in a semi-dry manner by the manufacturing method, so that the composite carbonate can be efficiently produced. In addition, the composite carbonate can be utilized as a component for a concrete composition.

### TECHNICAL FIELD

The present disclosure relates to a method for manufacturing a composite carbonate, using combustion ash.

### BACKGROUND ART

With the change of perception for carbon dioxide as a useful resource, active research has recently been conducted into the capture and utilization of carbon dioxide. In cooperation with carbon dioxide geologic storage, carbon dioxide capture and usage is a strategy for reducing carbon dioxide. In spite of its frequent use as a raw material in the food and material fields, carbon dioxide was separately regarded as a substance to be reduced when released, and thus has not attracted attention as a useful target. Techniques for carbon dioxide capture and utilization find applications in various fields including biofuel production, carbonate mineralization, polymerization, conversion into fuels, etc.

Of the techniques for carbon dioxide capture and utilization, carbonate mineralization is a relatively simple method that is expected to be commercialized in the near future. This method takes advantage of a carbonate precipitation reaction in which carbon dioxide is introduced into an aqueous solution containing cations such as Ca²⁺, etc., to form carbonate ions, followed by recovering a carbonate as a precipitate.

The carbonate mineralization technique is largely divided into a wet method and a dry method. For the wet method, an excess of water is used relative to combustion ash (about 1:50 ratio). The large amount of water causes the problem of producing waste water after treatment with a large amount of water. In addition, the energy cost for a drying process conducted on the carbonate generated after water treatment makes the wet method ineffective. The dry method also suffers from the problems of requiring a special adsorbent for capturing the carbon existing in the carbonate produced, and conducting a process at a high temperature. Therefore, a technique that overcomes the limitations of the wet and dry methods is necessary for producing high quality calcium carbonate.

For related documents, reference may be made to Korean Patent Number 10-1139398 (issued on Apr. 27, 2012) titled “Process for rapid production of calcium carbonate with micro bubble carbon dioxide on high yield”.

When electricity is generated using bituminous coal as a fuel in a heat power plant, fly ash and bottom ash are also produced. Only a small amount of the by-products is used as a concrete solidifying agent, a concrete admixture, or a cement fuel, and the remainder is discarded.

In addition, when solid refused fuel (SRF) is combusted in a power plant, combustion ash is generated and, for the most part, buried for disposal.

### SUMMARY

### Technical Problem

The present disclosure provides a method for manufacturing a composite carbonate in a semi-dry manner using combustion ash containing calcium ions.

However, the objectives to be achieved in the present disclosure are not limited to the above-described objectives. Other objectives, although not described herein, could be clearly understood by those skilled in the art from the following descriptions.

### Technical Solution

Leading to the present disclosure, intensive and thorough research, conducted by the present inventors, into effective carbonate mineralization, resulted in the finding that a composite carbonate can be obtained through carbonate mineralization by adding a small amount of water to combustion ash containing calcium ions.

Therefore, the present disclosure provides a semi-drying method for manufacturing a composite carbonate, the method comprising a step of adding water to combustion ash containing calcium ions.

In an embodiment of the present disclosure, the water is added in an amount of 10 to 100 parts by weight, based on 100 parts by weight of the combustion ash.

In another embodiment of the present disclosure, the combustion ash is solid refuse fuel combustion ash or circulating fluidized bed combustion ash.

In another embodiment of the present disclosure, the combustion ash is fly ash or bottom ash.

In another embodiment of the present disclosure, the carbon dioxide atmosphere contains 10% by volume to 100% by volume of carbon dioxide.

In addition, the present disclosure provides a method for preparing a concrete composition by blending the composite carbonate manufactured by the manufacturing method with water, cement, sand, pebbles, and an admixture.

Furthermore, the present disclosure provides a solidifying agent composition comprising the composite carbonate manufactured by the manufacturing method.

Moreover, the present disclosure provides a filler composition comprising the composite carbonate manufactured by the manufacturing method.

### Advantageous Effects

Based on the finding that a composite carbonate can be obtained by a semi-dry process of adding a small amount of water to combustion ash, the method for manufacturing a composite carbonate according to the present disclosure can overcome the problem of the wet method that produces a large amount of waste water and requires much cost and time consumption for a drying process due because a large amount of water is used and the limitation of the drying method that should be conducted at high temperatures.

In the present disclosure, a composite carbonate manufactured through mineralization of solid refuse fuel combustion ash or circulating fluidized bed combustion ash can be blended with cement, finding applications as an alternative material in a concrete composition and as a solidifying agent or filler in concrete.

### BRIEF DESCRIPTION OF THE DRAWINGS

FIG. 1 shows appearances of combustion ashes used in the present disclosure.

FIG. 2 shows SEM images of combustion dusts.

FIG. 3 shows particle size distributions of combustion dusts.

FIG. 4 shows EDS analysis results of combustion ashes.

FIG. 5 shows particle size distributions of bottom ashes as measured by sieving.

FIG. 6 shows images of bottom ashes divided by sieving according to particle sizes.

FIG. 7 shows XRD analysis results of combustion ashes.

FIG. 8 shows TG-DTA analysis results of combustion ashes.

FIG. 9 schematically shows a carbon reactor used for carbon mineralization of combustion ash in the present disclosure.

FIG. 10 shows appearances of slaked lime according to amounts of water added.

FIG. 11 shows characteristics of minerals according to carbon mineralization conducted by adding water to slaked lime, as measured by Q-XRD.

FIG. 12 shows changes in characteristics of minerals according to carbon mineralization conducted by adding water to slaked lime, as measured by Q-XRD.

FIG. 13 shows characteristics of minerals according to carbon mineralization conducted by adding water to SRF combustion ash, as measured by Q-XRD, in which content % is given all of the ingredients in the samples.

FIG. 14 shows changes in characteristics of minerals according to carbon mineralization conducted by adding water to SRF combustion ash, as measured by Q-XRD, in which content % is given to calcium-containing ingredients in the samples.

FIG. 15 shows characteristics of minerals according to reaction time, as measured by Q-XRD, in which content % is given all of the ingredients in the samples.

FIG. 16 shows changes in characteristics of minerals according to reaction time, as measured by Q-XRD, in which content % is given to calcium-containing ingredients in the samples.

FIG. 17 shows characteristics of minerals according to carbon dioxide concentration, as measured by Q-XRD, in which content % is given all of the ingredients in the samples.

FIG. 18 shows changes in characteristics of minerals according to carbon dioxide concentration, as measured by Q-XRD, in which content % is given to calcium-containing ingredients in the samples.

### DETAILED DESCRIPTION

In a power plant such as a heat power plant, combustion leaves combustion ash. When subjected to carbon mineralization, combustion ash can be advantageously utilized as an ingredient in a concrete composition. However, conventional carbon mineralization resorts mainly to a wet method using an excess of water or a dry method that is conducted at high temperatures. Due to the problems thereof, the wet and dry methods are difficult to utilize.

The present inventors conducted a study to offer a commercialized carbon mineralization strategy for combustion ash and found that a composite carbonate can be obtained using a semi-dry carbon mineralization method in which water is added in an amount of 10 to 100 parts by weight to combustion ash, based on 100 parts by weight of combustion ash, leading to the present disclosure.

Therefore, the present disclosure provides a method for manufacturing a composite carbonate from combustion ash, the method comprising a step of adding water in an amount of 10 to 100 parts by weight to 100 parts by weight of combustion ash.

As a rule, Ca compounds such as gehlenite (Ca₂Al[AlSiO₇]), anhydrite (CaSO₄), lime (Ca(OH)₂), and the like, exist in solid refuse fuel combustion ash and circulating fluidized bed combustion ash. In the present disclosure, a composite carbonate is manufactured by preparing CaCO₃ through a reaction between a small amount of water and CO₂.

The reaction may be conducted according to the following Reaction Scheme 1:

CaO+H₂O→Ca(OH)₂

Ca(OH)₂+CO₂→CaCO₃+H₂O <Reaction Scheme 1>

As illustrated above, the addition of water is indispensable for the production of CaCO₃ by reacting a Ca compound with CO₂. Generally, use of a large amount of water is followed by consuming much energy and time in drying the carbonate to be used in cement. The present disclosure provides a method for synthesizing a composite carbonate in a semi-dry manner designed to minimize the amount of water. Small energy can be consumed for drying the composite carbonate because it is synthesized with a small amount of water. The composition carbonate is easy to handle because it is in a powder form.

The combustion ash may be solid refuse fuel (SRF) combustion ash or circulating fluidized bed combustion (CFBC) combustion ash. For the SRF combustion ash and the CFBC combustion ash, both fly ash and bottom ash may be available.

In addition, the water may be added in an amount of 10 to 100 parts by weight, based on 100 parts by weight of the combustion ash. When the amount of water exceeds 100 parts by weight, much energy and time is required for the drying process. Water less than 10 parts by weight is insufficient to evenly wet the combustion ash and thus cannot allow the production of uniform composite carbonate. When account is taken of the energy and time for demoisturization, water is more preferably added in an amount of 25 to 75 parts by weight.

In the manufacturing method of the present disclosure, a small amount of water is added to combustion ash in a carbon dioxide atmosphere so that Ca compounds in the combustion ash reacts with carbon dioxide to produce calcium carbonate (CaCO₃). This reaction is carried out in a carbon dioxide reactor. In some particular embodiments, the reactor contains carbon dioxide at a concentration of 10% by volume to 100% by volume.

The combustion ash may contain calcium oxide (CaO), silicon dioxide (SiO₂), aluminum oxide (Al₂O₃), sodium oxide (Na₂O), iron oxide (Fe₂O₃), magnesium oxide, potassium oxide (K₂O), sulfur oxide (SO₃), and phosphorus pentoxide (P₂O₅).

The SRF fly ash may contain 10 to 25% by weight of calcium oxide (CaO), 15 to 40% by weight of silicon dioxide (SiO₂), 10 to 20% by weight of aluminum oxide (Al₂O₃), 10 to 20% by weight of sodium oxide (Na₂O), 1 to 5% by weight of iron oxide (Fe₂O₃), 0.5 to 3% by weight of magnesium oxide, 1 to 5% by weight of potassium oxide (K₂O), 0.5 to 2% by weight of sulfur oxide (SO₃), and 1 to 5% by weight of phosphorus pentoxide (P₂O₅).

The CFBC fly ash may contain 5 to 15% by weight of calcium oxide (CaO), 70 to 90% by weight of silicon dioxide (SiO₂), 2 to 4% by weight of aluminum oxide (Al₂O₃), 0.5 to 2% by weight of sodium oxide (Na₂O), 0.5 to 1% by weight of iron oxide (Fe₂O₃), 0.1 to 1% by weight of magnesium oxide (MgO), 0.1 to 0.5% by weight of potassium oxide (K₂O), 0.01 to 1% by weight of sulfur oxide (SO₃), and 0.1 to 1.5% by weight of phosphorus pentoxide (P₂O₅).

The SRF bottom ash may contain 10 to 40% by weight of calcium oxide (CaO), 10 to 30% by weight of silicon dioxide (SiO₂), 5 to 15% by weight of aluminum oxide (Al₂O₃), 1 to 3% by weight of sodium oxide (Na₂O), 10 to 20% by weight of iron oxide (Fe₂O₃), 5 to 15% by weight of magnesium oxide (MgO), 0.1 to 1% by weight of potassium oxide (K₂O), 0.01 to 0.5% by weight of sulfur oxide (SO₃), and 5 to 15% by weight of phosphorus pentoxide (P₂O₅).

The CFBC bottom ash may contain 15 to 40% by weight of calcium oxide (CaO), 10 to 30% by weight of silicon dioxide (SiO₂), 3 to 8% by weight of aluminum oxide (Al₂O₃), 1 to 3% by weight of sodium oxide (Na₂O), 10 to 15% by weight of iron oxide (Fe₂O₃), 5 to 15% by weight of magnesium oxide (MgO), 0.1 to 1% by weight of potassium oxide (K₂O), 15 to 35% by weight of sulfur oxide (SO₃), and (P₂O₅) 0.01 to 0.2% by weight of phosphorus pentoxide.

In addition, the present disclosure provides a method for preparing a concrete composition, the method comprising a step of blending the composite carbonate manufactured by the manufacturing method with water, cement, sand, pebbles, and an admixture.

The composition may comprise 50 to 70 parts by weight of water, 15 to 20 parts by weight of the composite carbonate, 280 to 320 parts by weight of sand, 300 to 350 parts by weight of pebbles, 0.5 to 1.5 parts by weight of an admixture, based on 100 parts by weight of the cement.

The cement may be Portland cement, the admixture may be a polycarbonate admixture, and the cement composition may comprise any ingredient available for typical cement composition in addition to the composite carbonate, without limitations imparted thereto.

Furthermore, the present disclosure provides a solidifying agent composition or filler composition comprising the composite carbonate manufactured by the manufacturing method.

The solidifying agent composition comprising the composite carbonate may be prepared through a step of adding sand, water, cement, or an admixture to the composite carbonate, and may contain any ingredient available for a concrete solidifying agent, without limitations.

The filler composition comprising the composite carbonate may be prepared through a step of adding sand, water, cement, or an admixture to the composite carbonate, and may contain any ingredient available for a concrete filler, without limitations.

Hereinafter, the present disclosure will be described in detail through the following Examples. It should be obvious to a person skilled in the art that the Examples are given to illustrate, but are not to be construed to limit the present disclosure.

### EXAMPLES

A better understanding of the present disclosure may be obtained through the following examples which are set forth to illustrate, but are not to be construed as limiting the present disclosure.

### Example 1: Characterization of Combustion Ash

1.1. Preparation of Combustion Ash

In this Example, solid refuse fuel (SRF) combustion ash and circulating fluidized bed combustion (CFBC) combustion ash were used for manufacturing composite carbonates. SRF fly ash (combustion dust) and bottom ash (combustion residue) were purchased from the Kwangju-Jeonnam Branch of the Korea District Heating Corporation while CFBC fly ash and bottom ash were obtained from the Samcheok Heat Power Plant in Korea Southern Power Co. Ltd.

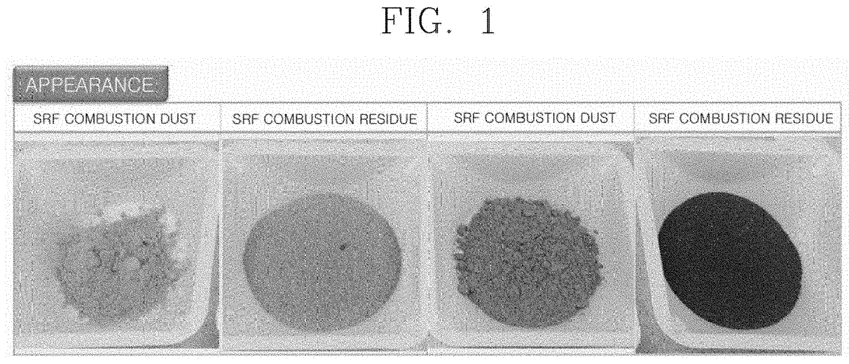

Appearances of the combustion ashes are depicted in FIG. 1.

1.2. Analysis for Chemical Ingredients of Combustion Ashes

The obtained combustion ashes were analyzed for chemical components, using ICP-OES (OPTIMA 8300, PERKINELMER), and the results are summarized in Table 1, below. For comparison, the SRF combustion dust obtained from Busan E&E (Busan Environment and Energy) and the coal combustion dust obtained from a coal power plant were analyzed for chemical components.

TABLE 1

| | | | | | | | | | | | Cl |
|---|---|---|---|---|---|---|---|---|---|---|---|
| Sample | SiO₂ | Al₂O₃ | Fe₂O₃ | CaO | MgO | Na₂O | K₂O | SO₃ | P₂O₅ | LOI | (ppm) |
| SRF combustion dust | 24.9 | 13.2 | 2.56 | 17.1 | 1.82 | 13.1 | 2.36 | 1.29 | 2.96 | 19.3 | 128,000 |
| SRF combustion residue | 85.0 | 2.90 | 0.87 | 7.27 | 0.50 | 1.01 | 0.35 | 0.18 | 0.94 | 0.02 | 2,000 |
| CFBC combustion dust | 19.7 | 9.06 | 16.6 | 25.3 | 11.2 | 1.91 | 0.89 | 0.15 | 11.1 | 3.73 | 28,800 |
| CFBC combustion residue | 20.9 | 5.19 | 12.9 | 23.1 | 7.94 | 1.27 | 0.61 | 24.7 | 0.13 | 2.56 | 8,600 |
| Busan SRF combustion dust | 7.56 | 6.57 | 2.00 | 15.4 | 1.66 | 24.7 | 2.94 | 0.55 | 2.42 | 33.9 | 51,924 |
| (obtained March, 2015) | | | | | | | | | | | |
| Coal combustion dust | 54.9 | 20.6 | 6.77 | 5.3 | 2.10 | 1.50 | 1.72 | 0.76 | 0.60 | 5.05 | tr |

SRF combustion dust contained CaO in an amount of 17.1%, Na₂O in an amount of 13.1%, and CI at a content of 128,000 ppm, which were measured to be similar to the chemical composition of Busan E&E SRF combustion dust.

1.3. SEM Analysis

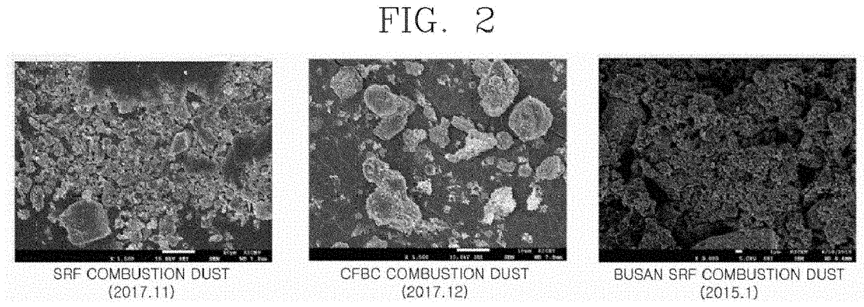

Powder morphologies of combustion dusts were observed. Images of combustion dust taken by a scanning electron microscope (JSM-7610F, JEOL) are given in FIG. 2.

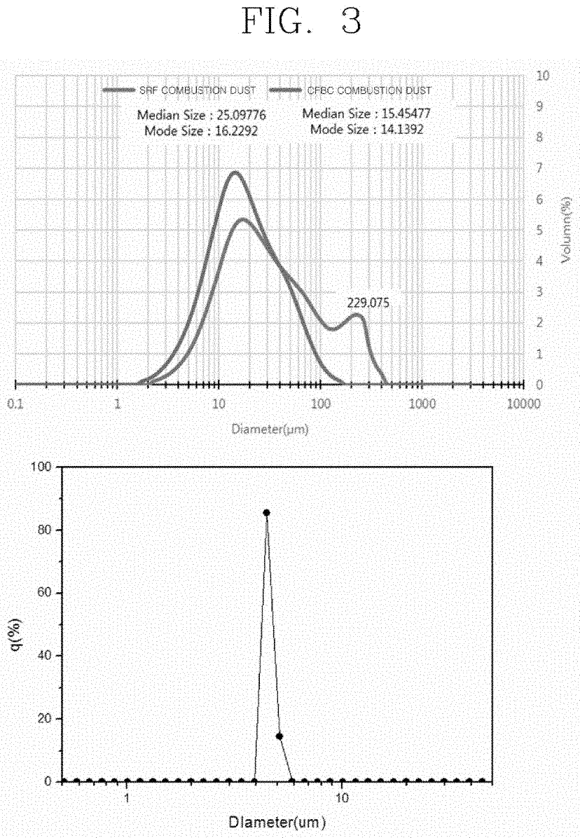

In addition, FIG. 3 shows the particle size distributions, with average particle diameters of 25.1 μm for SRF combustion dust, 15.5 μm for CFBC combustion dust, and 4.2 μm for Busan SRF combustion dust.

1.4. EDS Analysis

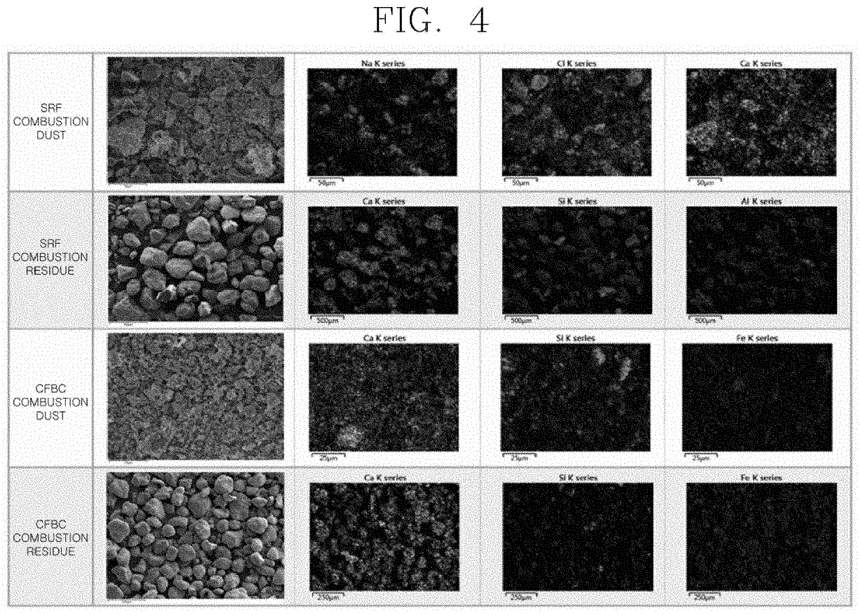

For component analysis, combustion dusts and combustion residues were subjected to energy dispersive X-ray spectroscopy (X-MAX 50, OXFORD), and the results are given in FIG. 4.

As can be seen in FIG. 4, Ca was observed to be distributed.

1.5. Particle Size Distribution by Sieving

The combustion ashes were sieved and measured for particle size distribution in order to determine whether the combustion ashes meet dimensions of fine aggregates for concrete.

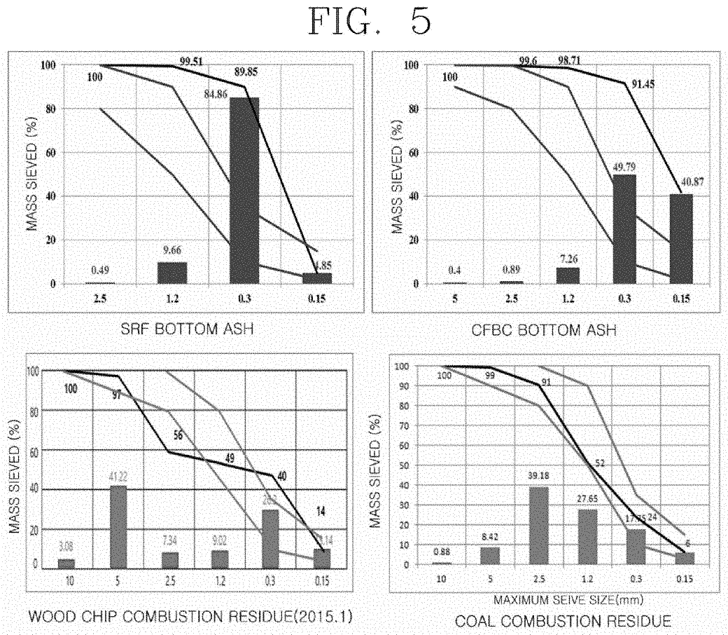

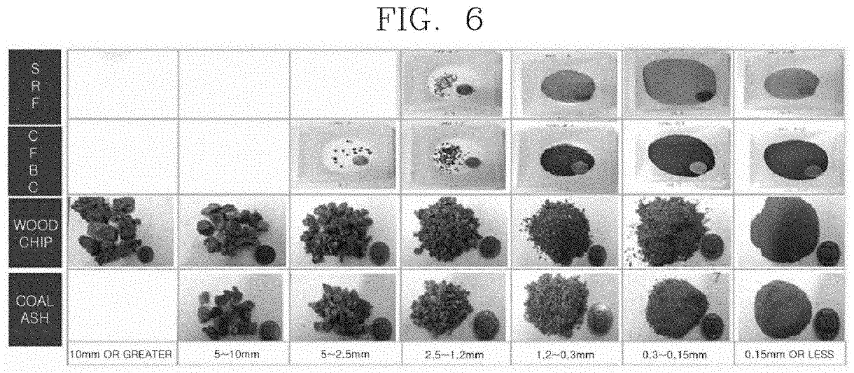

As shown in FIGS. 5 and 6, SRF combustion ash and CFBC bottom ash were finer than woodchip combustion residues and coal combustion residues.

From the results, it can be understood that particle sizes of SRF combustion ash and CFBC bottom ash are fine and do not meet the dimension of fine aggregates for concrete (KS F 2526).

1.6. XRD Analysis

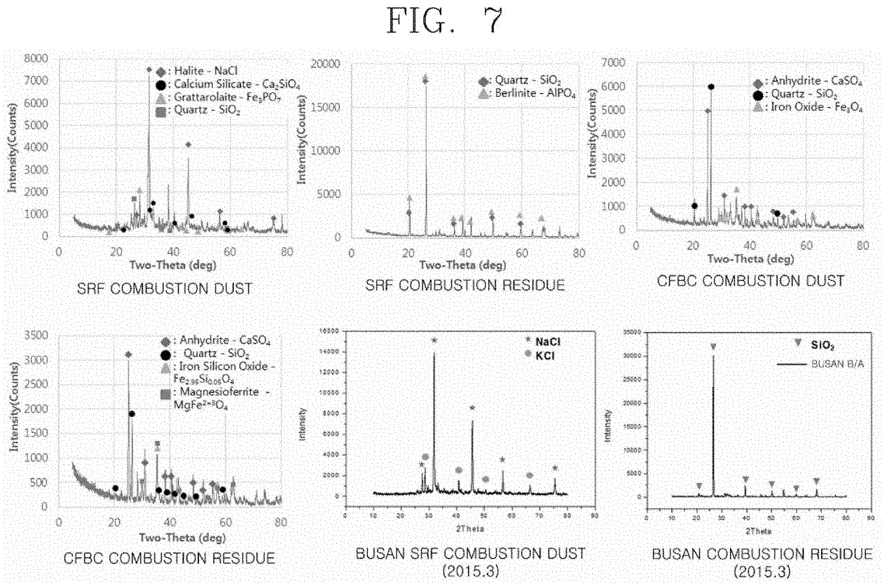

Components of the combustion ashes and combustion residues were analyzed using XRD (G-MAX 2500, RIGAKU), and the results are given in FIG. 7.

As is understood from data of FIG. 7, Ca compounds were detected in SRF combustion ash, but not in SRF bottom ash.

1.7. TG-DTA Analysis

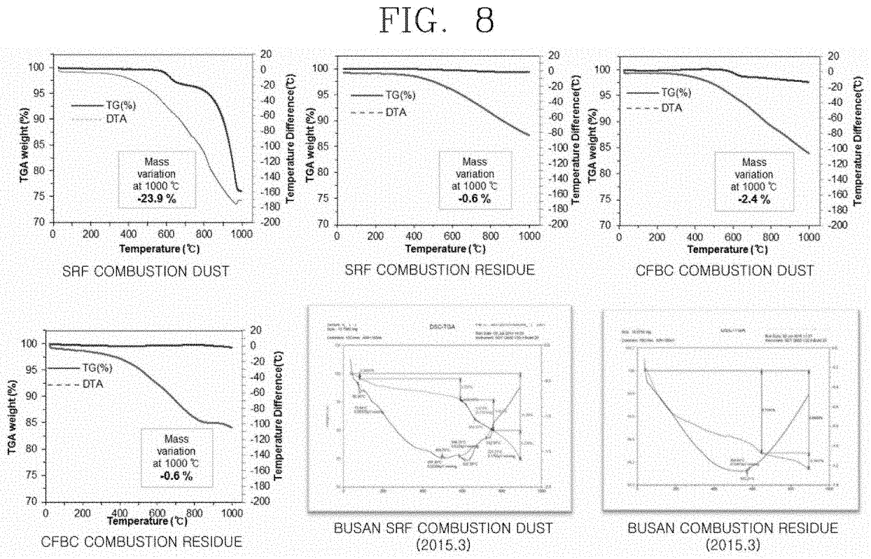

The combustion dusts and combustion residues were quantitatively analyzed for Ca compounds by thermogravimetry (TG-DTA, Thermo Plus Evo 2, RIGAKU), and the results are given in FIG. 8.

As shown in FIG. 8, Ca compounds were most abundantly detected in SRF combustion ash, amounting to about 24%.

1.8. Waste Leaching Test

In order to determine whether combustion ashes and combustion residues are designated waste or general waste, a waste leaching test was performed on SRF and CFBC combustion dusts and combustion residues, and Busan SRF combustion ashes according to the Standard Test for Wastes (the National Institute of Environmental Research Notice No. 2017-20, Aug. 11, 2017).

The analysis results are summarized in Table 2.

TABLE 2

| | | | | | | | | | | Busan SRF |
|---|---|---|---|---|---|---|---|---|---|---|
| | Standard | | | | | | | | | Combustion |
| | for | SRF | | | | CFBC | | | | ash |
| Analysis | designated | Combustion dust | | Combustion residue | | Combustion dust | | Combustion residue | | (combustion |
| Item | waste | KICET*¹ | KCL*² | KICET | KCL | KICET | KCL | KICET | KCL | dust) |
| Pb or its Cpd. | 3 mg/l or more | not | 0.11 | not | not | not | 0.05 | not | not | 32.7 |
| | | detected | | detected | detected | detected | | detected | detected | |
| Cu or its Cpd. | 3 mg/l or more | not | 0.127 | not | 0.028 | not | 0.03 | not | 0.013 | 0.24 |
| | | detected | | detected | | detected | | detected | | |
| As or its Cpd. | 1.5 mg/l or more | not | not | not | not | not | not | not | not | 0.01 |
| | | detected | detected | detected | detected | detected | detected | detected | detected | |
| Pb or its Cpd. | 0.005 mg/l or more | not | not | not | not | not | not | not | not | 0.13 |
| | | detected | detected | detected | detected | detected | detected | detected | detected | |
| Cd or its Cpd. | 3 mg/l or more | not | not | not | not | not | not | not | not | 0.01 |
| | | detected | detected | detected | detected | detected | detected | detected | detected | |
| Hexavalent Cr | 1.5 mg/l or more | 0.01 | not | 0.05 | not | not | not | not | not | not |
| Cpd. | | | detected | | detected | detected | detected | detected | detected | detected |
| Cyanide | 1.0 mg/l or more | not | not | not | not | not | not | not | not | |
| | | detected | detected | detected | detected | detected | detected | detected | detected | |
| Organic P Cpd. | 1.0 mg/l or more | not | not | not | not | not | not | not | not | |
| | | detected | detected | detected | detected | detected | detected | detected | detected | |
| PCBs | 0.003 mg/l or more | not | | not | | not | | not | | |
| | | detected | | detected | | detected | | detected | | |
| Tetrachloro- | 0.1 mg/l or more | not | | not | | not | | not | | |
| ethylene | | detected | | detected | | detected | | detected | | |
| Trichloro- | 0.3 mg/l or more | not | | not | | not | | not | | |
| ethylene | | detected | | detected | | detected | | detected | | |
| Cl | | | | | | | | | | |
| Halogenated | 5 mg/l or more | not | | not | | not | | not | | |
| organic | | detected | | detected | | detected | | detected | | |
| substance | | | | | | | | | | |
| Oily ingredient | 5% or more | not | not | not | not | not | not | not | not | |
| | | detected | detected | detected | detected | detected | detected | detected | detected | |

*¹KICET (Korea Institute of Ceramic Engineering and Technology)
*²KCL (Korea Conformity Laboratories)

As shown in Table 2, measurements of all of the combustion dusts and combustion residues in both KICET and KCL were observed to fall behind the standards for designated wastes. Therefore, the SRF combustion dusts and combustion residues and CFBC combustion dusts and combustion residues used in the present disclosure are suitable for use as cement materials.

1.9. Heavy Metal Content

The combustion dusts and combustion residues were measured for heavy metal contents, using the method of EPA 3051A: 2007, and the results are summarized in Table 3, below.

TABLE 3

| | | | Heavy Metal | | | | |
|---|---|---|---|---|---|---|---|
| Sample | | Cl | Pb | Cu | Cd | As | Hg |
| Standard for use as alternative cement | | 20,000 | 150 | 800 | 50 | 50 | 2.0 |
| material | | | | | | | |
| SRF combustion dust | | 128,000 | 785 | 5,620 | 33 | N.D | N.D |
| SRF combustion residue | | 2,000 | 74 | 2,240 | N.D | N.D | N.D |
| CFBC combustion dust | | 28,800 | N.D | 265 | N.D | N.D | N.D |
| CFBC combustion residue | | 8,600 | N.D | 149 | N.D | N.D | N.D |
| Busan SRF | 51,924 | 653 | 5,007 | 106 | 106 | not | N.D. |
| | | | | | | detected | |
| | 12,342 | not | 4,564 | 19 | 19 | not | N.D. |
| | | detected | | | | detected | |
| | 44 | not | 2,609 | 6 | 6 | not | N.D. |
| | | detected | | | | detected | |

As is understood from data of Table 3, the SRF combustion ash contained heavy metals at concentrations higher than the standards for use as alternative cement material according to the wastes control act. The SRF combustion residue was lower in chlorine and heavy metal contents than the SRF combustion ash, and contained Cu at a level higher than the standard for use as alternative cement material.

1.10. Carbon Mineralization Method

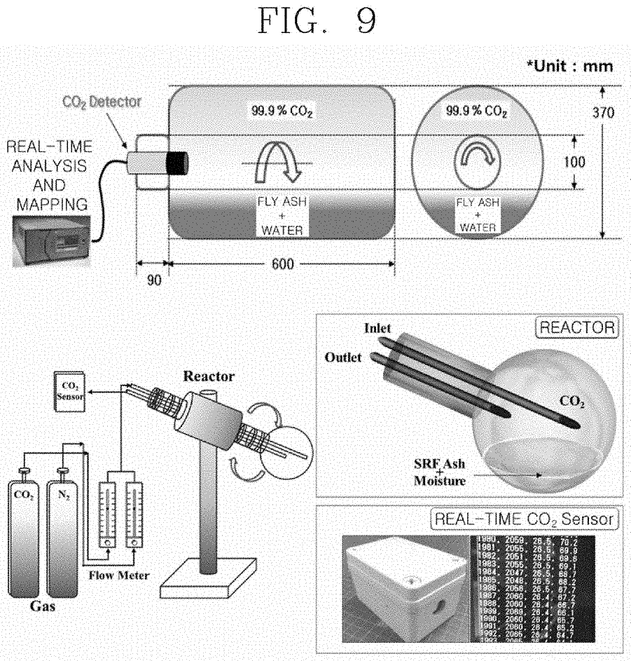

For use in establishing a semi-dry carbon mineralization method for manufacturing a composite carbonate, as shown in FIG. 9, a batch-type CO₂ reactor (size: 50l) was constructed and equipped with a real-time CO₂ gas analyzer. In this reactor, CO₂ was employed at a concentration of 60% by volume.

The capability of the reactor, which is calculated according to the following reaction scheme, can convert about 163 g of Ca(OH)₂ to about 200 g of CaCO₃.

CaO+H₂O→Ca(OH)₂ \textcircled{1}

Ca(OH)₂+CO₂→CaCO₃+H₂O \textcircled{2}

### Example 2: Carbon Mineralization Using Slaked Lime

In Example 2, a preparative experiment for carbon mineralization of combustion ash was conducted to examine whether semi-dry carbonate can be produced from slaked lime by controlling an amount of water.

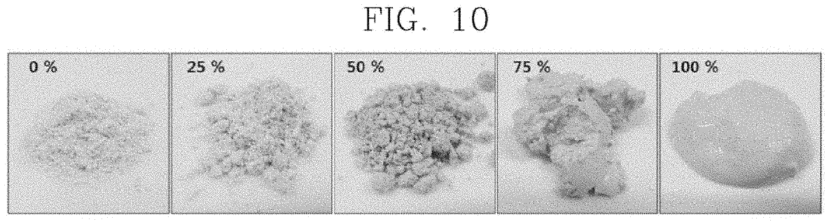

In this regard, water was added to 200 g of slaked lime in the batch-type CO₂ reactor (CO₂ concentration: 60 vol. %) and they were reacted at room temperature for 1 hour. Water was used in amounts of 0%, 25% (50 g), 50% (100 g), 75% (150 g), and 100% (200 g) (FIG. 10).

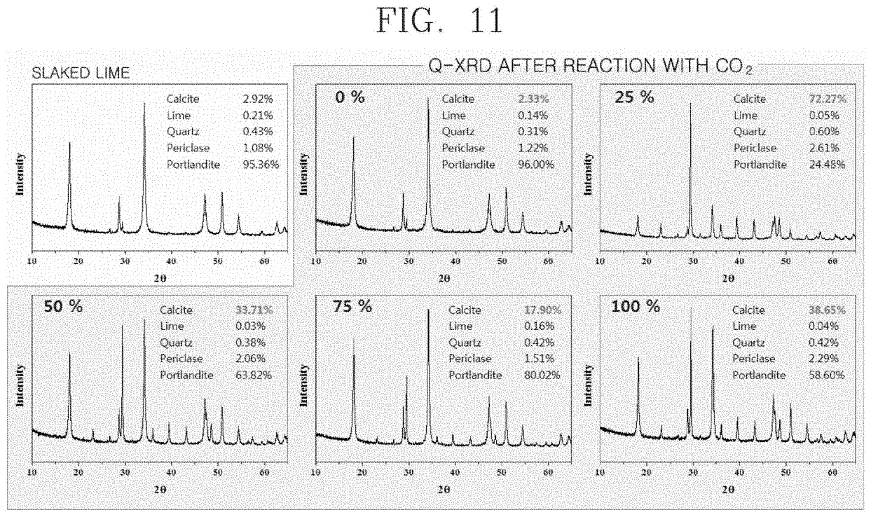

After water addition, characteristics of minerals were analyzed using Q-XRD (X PERT PRO, PANALYTICAL B.V.), and the results are depicted in FIG. 11.

As shown in FIG. 11, CaCO₃ (calcite) was most abundantly converted from CaOH when water was added in an amount of 25%.

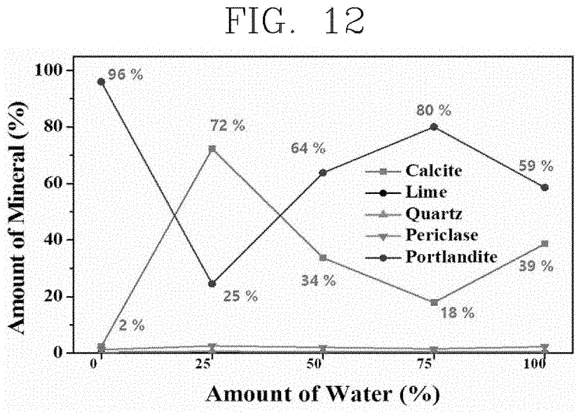

In addition, the characteristics of minerals identified by Q-XRD are schematically depicted in FIG. 12. As shown in FIG. 12, it was observed that the conversion was less likely to occur in the presence of larger amounts of water.

### Example 3: Carbon Mineralization Using Combustion Ash

In Example 3, carbon mineralization was performed on combustion ash on the basis of the results of Example 2.

3.1. Characterization of Carbon Mineralization According to Amount of Water

In the batch-type CO₂ reactor (CO₂ concentration: 60 vol. %), water was added to 200 g of SRF fly ash and they were reacted at room temperature for 1 hour. Water was used in amounts of 0%, 25% (50 g), 50% (100 g), 75% (150 g), and 100% (200 g).

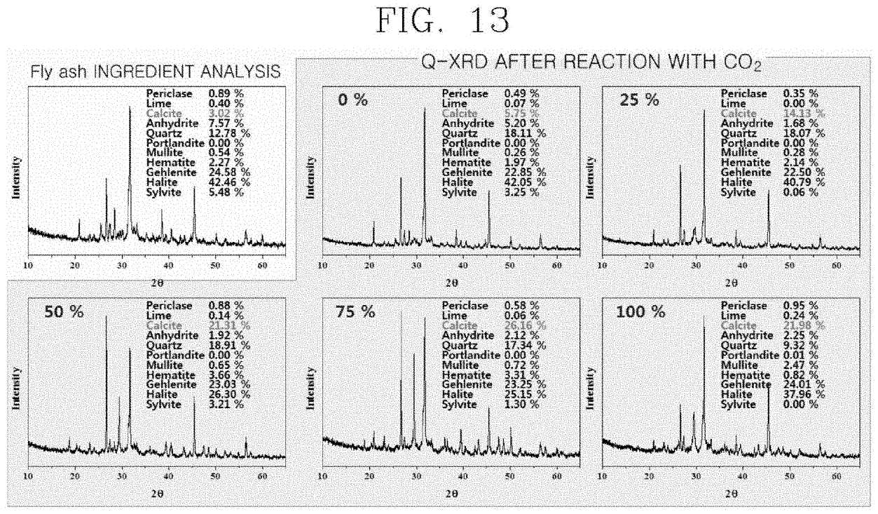

After water addition, characteristics of minerals were analyzed using Q-XRD (X PERT PRO, PANALYTICAL B.V.), and the results are depicted in FIG. 13.

As shown in FIG. 13, CaOH started to convert into CaCO₃ when water was added in an amount of 25% and was most abundantly converted at 75% of water.

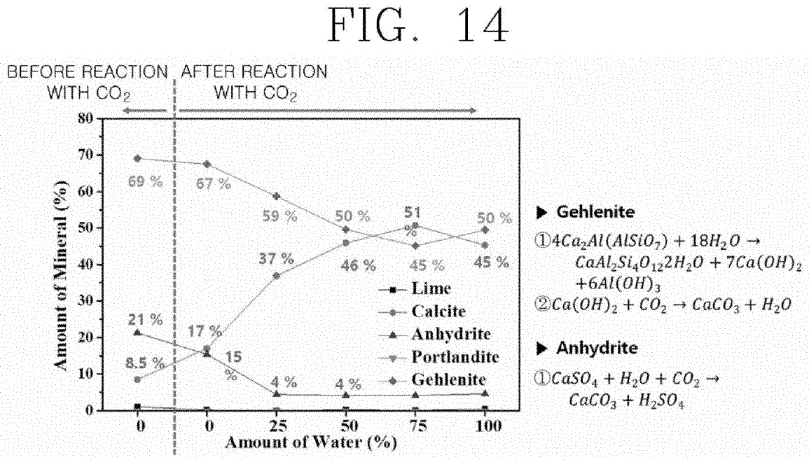

In addition, the characteristics of minerals identified by Q-XRD were schematically depicted and changes of calcium-containing ingredients are given in FIG. 14. As shown in FIG. 14, effective conversion to CaCO₃ was achieved when water was added in an amount of 25 to 100%.

3.2. Characterization of Carbon Mineralization with Reaction Time

In the batch-type CO₂ reactor (CO₂ concentration: 10 vol. %), water was added to 200 g of SRF fly ash. The amount of water was fixed as 20%. They were reacted at room temperature for 1 min, 5 min, 10 min, and 30 min. Characteristics of minerals were analyzed by Q-XRD (X PERT PRO, PANALYTICAL B.V.).

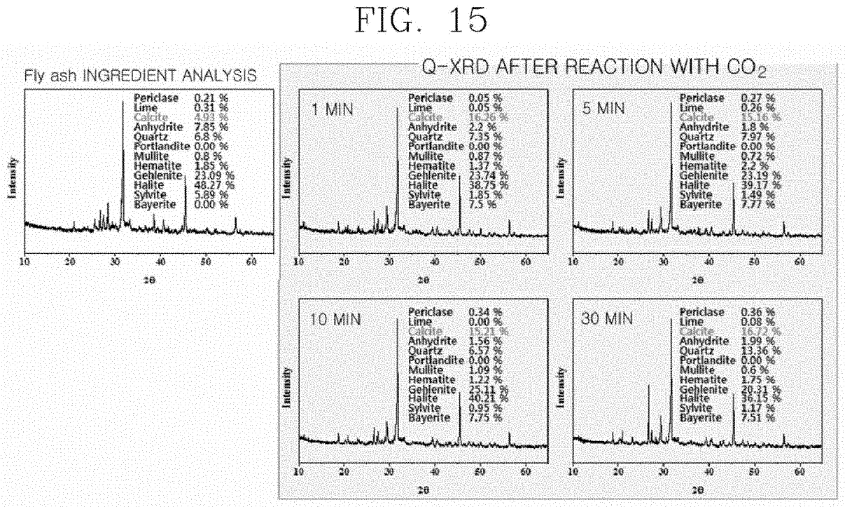

The results are depicted in FIG. 15. As can be seen, the content of calcite in fly ash was 4.93% before the reaction and increased to 16.3% after 1 min of the reaction, indicating that a reaction is sufficiently induced for 1 min.

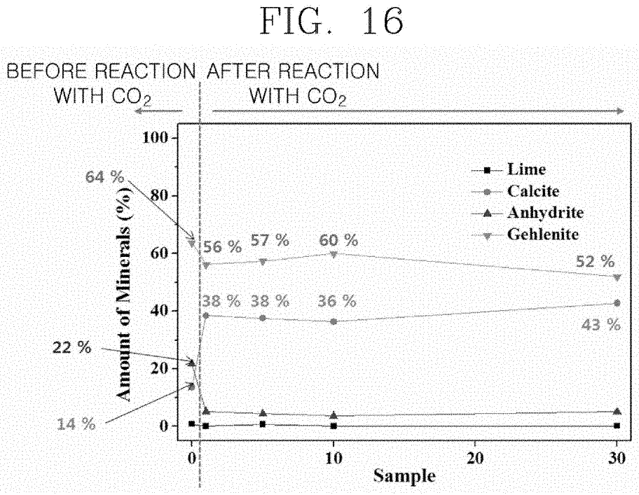

Furthermore, the characteristics of minerals identified by Q-XRD were schematically depicted and changes of calcium-containing ingredients are given in FIG. 16. As shown in FIG. 16, effective conversion to CaCO₃ was achieved even after 1 min of the reaction.

3.3. Characterization of Carbon Mineralization According to Carbon Dioxide Concentration

In the batch-type CO₂ reactor, carbon dioxide was set to have a concentration of 10% by volume, 20% by volume, 50% by volume, and 100% by volume. In this condition, water was added at the fixed amount of 20% to 200 g of SRF fly ash. They were reacted at room temperature for 10 min. Characteristics of the minerals before and after the reaction were analyzed by Q-XRD (X PERT PRO, PANALYTICAL B.V.).

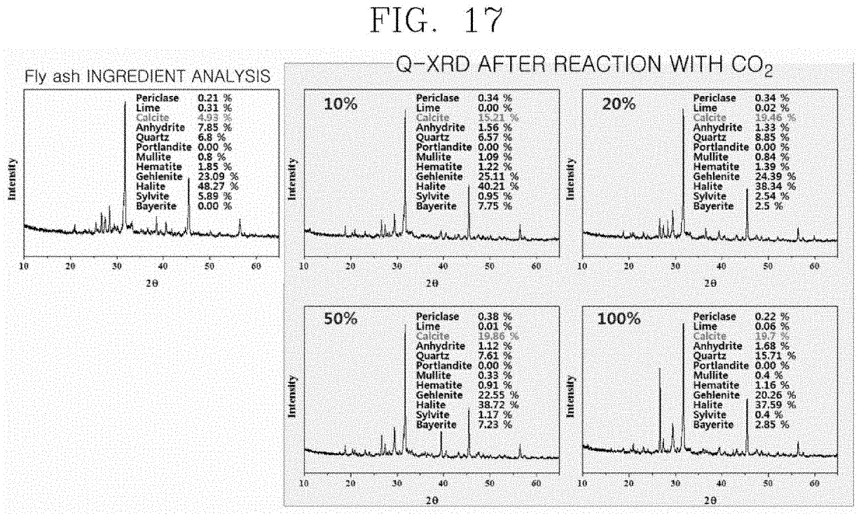

The results are given in FIG. 17. The content of calcite in fly ash was 4.93% before the reaction, increased to 15.21% at a carbon dioxide concentration of 10% and to 19.46% at a carbon dioxide concentration of 20%, with no significant difference in calcite content at a carbon dioxide concentration higher than 20%.

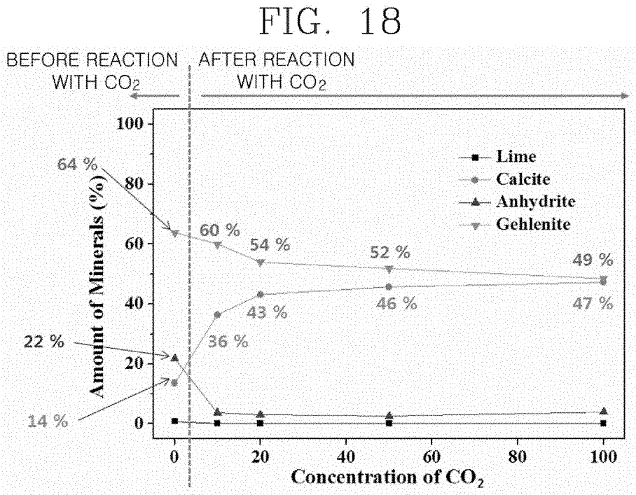

In addition, the characteristics of minerals identified by Q-XRD were schematically depicted and changes of calcium-containing ingredients are given in FIG. 18. As shown in FIG. 18, effective conversion to CaCO₃ was achieved at a carbon dioxide concentration of 20 to 100% by volume.

Taken together, the data obtained above demonstrate that the mineralization of solid refuse fuel combustion ash or circulating fluidized bed combustion ash by water addition according to the method of the present disclosure can produce semi-dry composite carbonate that can be used in substitution for cement.

Accordingly, it should be understood that simple modifications and variations of the present disclosure may be easily used by those skilled in the art, and such modifications or variations may fall within the scope of the present disclosure.

### INDUSTRIAL APPLICABILITY

The method for manufacturing a composite carbonate according to the present disclosure is a semi-dry method that overcomes all the limitations of conventional wet and dry methods, and the composite carbonate manufactured thereby can be utilized as an alternative ingredient in a concrete composition and as a solidifying agent or a filler in concrete.

1. A semi-dry method for manufacturing a composite carbonate from combustion ash, the method comprising a step of adding water to calcium ion-containing combustion ash in a carbon dioxide atmosphere.

2. The semi-dry method of claim 1, wherein the water is added in an amount of 10 to 100 parts by weight, based on 100 parts by weight of the combustion ash.

3. The semi-dry method of claim 1, wherein the combustion ash is solid refuse fuel combustion ash or circulating fluidized bed combustion ash.

4. The semi-dry method of claim 1, wherein the combustion ash is fly ash or bottom ash.

5. The semi-dry method of claim 1, wherein the carbon dioxide atmosphere contains carbon dioxide at a concentration of 10% by volume to 100% by volume.

6. A method for preparation of a concrete composition, comprising a step of blending the composite carbonate manufactured by the method of claim 1 with water, cement, sand, pebbles, and an admixture.

7. A solidifying composition, comprising the composite carbonate manufactured by the method of claim 1.

8. A filler composition, comprising the composite carbonate manufactured by the method of claim 1.

9. The semi-dry method of claim 2, wherein the combustion ash is fly ash or bottom ash.
